(19) United States
(12) Patent Application Publication
(10) Pub. No.: US 2009/0287438 A1
(43) Pub. Date: Nov. 19, 2009

(54) Increased Fault Diagnosis Throughput Using Dictionaries For Hyperactive Faults

(76) Inventors: Wu-Tung Cheng, Lake Oswego, OR (US); Huaxing Tang, Wilsonville, OR (US); Wei Zou, Wilsonville, OR (US); Manish Sharma, Wilsonville, OR (US)

Correspondence Address: MENTOR GRAPHICS CORP.;PATENT GROUP, 8005 SW BOECKMAN ROAD, WILSONVILLE, OR, 97070-7777, US

(21) Appl. No.: 12/335,453

(22) Filed: Dec. 15, 2008

Related U.S. Application Data
(60) Provisional application No. 61/014,020, filed on Dec. 14, 2007.
(60) Provisional application No. 61/055,900, filed on May 23, 2008.

(51) Int. Cl. G06F 19/00

(52) U.S. Cl. 702/81

(57) ABSTRACT

Techniques to achieve greater diagnostic speeds using relatively small fault dictionaries, such as dictionaries that are only slightly larger than so-called N_{FB} dictionaries. This speed-up may be achieved by identifying a set of faults called hyperactive faults, and creating a dictionary for identifying those faults.

### RELATED APPLICATIONS

This application claims priority to U.S. Provisional Patent Application No. 61/014,020, entitled “Increased Fault Diagnosis Throughput Using Dictionaries For Hyperactive Fault,” filed on Jan. 14, 2007, and naming Wu-Tung Cheng et al. as inventors, which application is incorporated entirely herein by reference. This application also claims priority to U.S. Provisional Patent Application No. 61/055,900, entitled “Increased Fault Diagnosis Throughput Using Dictionaries For Hyperactive Fault,” filed on May 23, 2008, and naming Wu-Tung Cheng et al. as inventors, which application is incorporated entirely herein by reference as well.

### FIELD OF THE INVENTION

The present invention is directed to the use of small fault dictionaries to rapidly diagnose faults in integrated circuits. Various implementations of the invention may be particularly useful for diagnosing faults for volume production of VLSI designs.

### BACKGROUND OF THE INVENTION

For volume production of VLSI designs, it is desirable to have fast and accurate diagnosis of manufacturing defects on a large number of chips in order to ramp up yields. Recently, several methods of speeding-up effect-cause fault diagnosis using fault-response dictionaries were introduced. Some of these methods use very large dictionaries that may not fit in available memories (even on large workstations), while others use small dictionaries that satisfy memory requirements but drastically reduce the speed gains possible using dictionary-based approaches.

### BRIEF SUMMARY OF THE INVENTION

Disclosed herein are methods to achieve greater diagnostic speeds using relatively small fault dictionaries (e.g., dictionaries only slightly larger than so-called N_{FB} dictionaries). In certain embodiments, this speed-up is achieved by identifying a set of faults called hyperactive faults for which a dictionary is created. Experimental results are presented demonstrating the effectiveness of an embodiment of the disclosed method.

Representative embodiments of methods, apparatus, and systems having particular applicability to testing, diagnosing, and improving the yield and quality of integrated circuits are disclosed herein that should not be construed as limiting in any way. Instead, the present disclosure is directed toward all novel and nonobvious features and aspects of the various disclosed methods, apparatus, and systems, and their equivalents, alone and in various combinations and subcombinations with one another. The disclosed technology is not limited to any specific aspect or feature, or combination thereof, nor do the disclosed methods, apparatus, and systems require that any one or more specific advantages be present or problems be solved.

Moreover, any of the methods, apparatus, and systems described herein can be used in conjunction with the manufacture and testing of a wide variety of integrated circuits (e.g., application-specific integrated circuits (ASICs), programmable logic devices (PLDs) such as a field-programmable gate arrays (FPGAs), or systems-on-a-chip (SoCs)), which utilize a wide variety of components (e.g., digital, analog, or mixed-signal components).

Although the operations of some of the disclosed methods are described in a particular, sequential order for convenient presentation, it should be understood that this manner of description encompasses rearrangement, unless a particular ordering is required by specific language set forth below. For example, operations described sequentially can be rearranged or performed concurrently. Moreover, for the sake of simplicity, the figures herein may not show the various ways in which the disclosed methods, apparatus, and systems can be used in conjunction with other methods, apparatus, and systems. Additionally, the description sometimes uses terms like “determine” and “identify” to describe the disclosed technology. These terms are high-level abstractions of the actual operations that are performed. The actual operations that correspond to these terms will vary depending on the particular implementation and are readily discernible by one of ordinary skill in the art.

The disclosed embodiments can be implemented in a wide variety of environments. For example, any of the disclosed techniques can be implemented in whole or in part as software comprising computer-executable instructions stored on one or more computer-readable media (e.g., tangible computer-readable media, such as one or more CDs, volatile memory components (such as DRAM or SRAM), or nonvolatile memory components (such as hard drives)). Such software can comprise, for example, electronic design automation (EDA) software tools (e.g., a failure diagnosis tool). The particular software tools described should not be construed as limiting in any way, however, as the principles disclosed herein are generally applicable to other software tools.

Such software can be executed on a single computer or on a networked computer (e.g., via the Internet, a wide-area network, a local-area network, a client-server network, or other such network). For clarity, only certain selected aspects of the software-based implementations are described. Other details that are well known in the art are omitted. For example, it should be understood that the disclosed technology is not limited to any specific computer language, program, or computer. For the same reason, computer hardware is not described in further detail. Any of the disclosed methods can alternatively be implemented (partially or completely) in hardware (e.g., an ASIC, PLD, or SoC).

Further, data produced from any of the disclosed methods can be created, updated, or stored on one or more computer-readable media (e.g., computer-readable media, such as one or more CDs, volatile memory components (such as DRAM or SRAM), or nonvolatile memory components (such as hard drives)) using a variety of different data structures or formats. For example, fault dictionaries generated according to embodiments of the disclosed technology can be stored on one or more computer-readable media. Such data can be created or updated at a local computer or over a network (e.g., by a server computer).

Moreover, any of the disclosed methods can be used in a computer simulation, ATPG, or other EDA environment, wherein test patterns, test responses, and compressed test responses are determined by or otherwise analyzed using representations of circuits and/or scan chains, which are stored on one or more computer-readable media. For presentation purposes, however, the present disclosure sometimes refers to a circuit or its circuit components by their physical counterpart (for example, scan cells, registers, logic gates, and other such terms). It should be understood, however, that any reference in the disclosure or the claims to a physical component includes representations of such circuit components as are used in simulation, ATPG, or other such EDA environments.

### BRIEF DESCRIPTION OF THE DRAWINGS

FIG. 1 illustrates a conventional technique for obtaining an initial list of fault candidates when a dictionary is used instead of the backtracing technique shown in FIG. 2.

FIG. 2 illustrates an example of a conventional backtracing technique for an effect-cause diagnosis procedure.

FIG. 3 illustrates a method of performing an effect-cause diagnosis procedure using an N_{FB} dictionary.

FIG. 4 illustrates an effect-cause diagnosis procedure using both the N_{FB} and HF dictionaries together according to various examples of the invention.

FIG. 5 illustrates the speed-up factor of an effect-cause diagnosis procedure according to various examples of the invention relative to a base line effect-cause diagnosis procedure that does not use a dictionary.

FIG. 6 illustrates an effect-cause diagnosis procedure flow using the HF dictionary alone according to various examples of the invention.

FIG. 7 illustrates the speed up factors for effect-cause diagnosis procedures on the circuit C5 (described in Table 2) using SD, NFB5, and HFNFB and HFOnly (i.e., using only the HF dictionary).

### DETAILED DESCRIPTION OF THE INVENTION

### Introduction to the Disclosed Technology

In deep sub-micron (DSM) designs, feature related systematic manufacturing defects are common and cause yield problems. Low yield devices are costly to manufacture. To shorten the time-to-market, the yield is desirably ramped up by quickly discovering and rectifying the causes for systematic defects. Volume diagnosis with statistical learning can be used to cost effectively discover systematic defects. An accurate and high throughput diagnosis tool can be used during such diagnosis to diagnose large numbers of failing devices and to aid statistical yield learning. Traditional effect-cause diagnosis procedures, which are commonly used in industry, are typically unable to handle the high volume data in time. Further, effect-cause diagnosis methods assisted with a dictionary are fast but may have an undesirably large dictionary size. The N_{FB} dictionary discussed in H. Tang et al., “Improving Performance of Effect-Cause Diagnosis with Minimal Memory Overhead,” Proc. Asian Test Symposium, pp. 281-287 (2007), reduces dictionary size, but can be very slow in diagnosing some designs. Disclosed herein are embodiments of a dictionary that can be used to store information on so-called “hyperactive” faults. By using such a dictionary, better diagnosis times can be obtained for larger designs.

As used in this disclosure, a passing (failing) bit generally refers to an observed output bit on the tester found to match (not to match) the expected value. A failing response generally refers to the circuit output values observed for a pattern having failing bits. A passing (failing) pattern generally refers to a pattern applied by a tester to a circuit under test the response to which does not have (has) failing bits. The number of failing bits generally refers to the number of failing bits associated with a pattern. The number of failing bits for a pattern Pⱼ when a candidate fault fᵢ is simulated for pattern Pⱼ is denoted as NFB(fᵢ, Pⱼ). The number of failing bits in a faulty response in the fail log (obtained during test) for pattern Pⱼ is denoted by NFB(Pⱼ). The minimum number of failing bits of a fault candidate fᵢ generally refers to the smallest number in the set {NFB(fᵢ, Pⱼ)|pattern Pⱼ detects fault candidate fᵢ}, which is denoted by minFB(fᵢ). Further, given a failing pattern P, if a fault fᵢ under simulation predicts the same failing response as the response of P on the tester, it can be said that the fault fᵢ explains failing pattern P. A failing pattern that cannot (can) be explained by a fault candidate fᵢ is referred to as a failing pattern mismatch (match) for fᵢ. A passing pattern that cannot (can) be explained by a fault candidate fᵢ is called a passing pattern mismatch (match) for fᵢ. The match and mismatch information can be used to assign a score to rank the final fault candidates/suspects reported by the diagnosis procedure.

### Review of Effect-Cause Diagnosis

Effect-cause diagnosis procedures are normally used in industry. Such procedures typically use Single Location at a Time (SLAT) patterns. See, e.g., T. Bartenstein et al, “Diagnosing Combinational Logic Design Using the Single Location At-a-Time (SLAT) Paradigm,” Proc. of ITC, pp. 287-296 (2001). SLAT patterns are those for which the observed failing response is explained by a single fault at a location. The single location faults simulated are a choice of the user/tool. Typically though, the faults simulated in effect-cause diagnosis procedures are single stuck-at faults. This does not mean that the diagnosis tool assumes that the defect being diagnosed is a single stuck-at fault, but rather that a particular pattern response is the same as the response to the test pattern due to a single stuck-at fault. SLAT patterns based on single stuck-at faults have been successfully used to locate defects such as bridges and opens, including multiple defects.

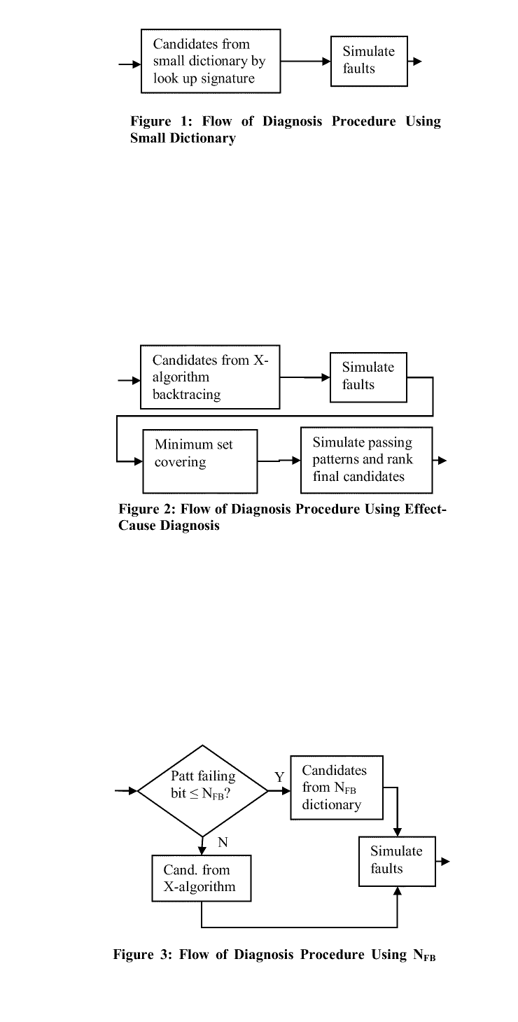

An exemplary effect-cause diagnosis procedure comprises the following method acts (see also FIG. 2):
For each failing pattern, backtrace from the failing observation points for each pattern to obtain an initial set of fault candidates. For example, the X-algorithm can be used. See, e.g., S. B. Akers et al., “Why is Less Information from Logic Simulation More Useful in Fault Simulation,” Proc. of ITC, pp. 786-800 (1990). Fault simulation can be used to remove or filter out the candidates that do not match the observed failing bits of the pattern.
Perform minimum set covering on the candidates obtained to find a minimal set of candidates to explain a maximum number of failing patterns. The selected candidates are typically referred to as suspects.
Simulate the suspects using the passing patterns and compute a score based on the passing/failing pattern match/mismatch. Rank the suspects based on their scores.

The advantage of effect-cause diagnosis is the small memory requirement. No dictionary is used and memory is available for holding larger designs and test patterns. The disadvantage is that fault simulation may waste time repeatedly on some time-consuming candidate faults that are filtered out. Using a dictionary, by contrast, could effectively alleviate this situation by filtering out such faults without simulation. Another time-consuming aspect of the effect-cause procedure is the time for backtracing to find the initial set of candidates. Using a dictionary, backtracing can be completely avoided.

One exemplary method to speed up effect-cause diagnosis with a small-signature-based dictionary was discussed in W. Zou et al., “Speeding Up Effect Cause Defect Diagnosis Using a Small Dictionary,” Proc. of VTS, pp. 225-230 (2007) and U.S. patent application Ser. No. 11/688,782, which is published as U.S. Patent Application Publication No. 2007/0226570. However, the size of the signature-based dictionary increases almost linearly with the number of test patterns. A limited-number-of-failing-bits based dictionary called the N_{FB} dictionary was discussed in H. Tang et al., “Improving Performance of Effect-Cause Diagnosis with Minimal Memory Overhead,” Proc. Asian Test Symposium, pp. 281-287 (2007) and U.S. Patent Application Publication No. 2007/0226570, to reduce the size of the signature-based dictionary, but the speed up over the standard effect-cause diagnosis relative to that obtained by using the small dictionary is much reduced for some designs. W. Zou et al., “Speeding Up Effect Cause Defect Diagnosis Using a Small Dictionary,” Proc. of VTS, pp. 225-230 (2007), H. Tang et al., “Improving Performance of Effect-Cause Diagnosis with Minimal Memory Overhead,” Proc. Asian Test Symposium, pp. 281-287 (2007), and U.S. Patent Application Publication No. 2007/0226570 are incorporated herein by reference.

In certain embodiments disclosed herein, the run time of the effect-cause diagnosis procedure is reduced by an amount over and above the reduction obtained by using the N_{FB} dictionary while using a dictionary whose size is only marginally larger than that of the N_{FB} dictionary.

### Signature-Based Small Dictionary

For the exemplary method using a signature-based small dictionary described in W. Zou et al., “Speeding Up Effect Cause Defect Diagnosis Using a Small Dictionary,” Proc. of VTS, pp. 225-230 (2007) and U.S. Patent Application Publication No. 2007/0226570, both of which are incorporated herein by reference, failing bit data for a pattern is compressed into a 32-bit signature. Unique signatures for each fault are stored in the dictionary. Clocks pulsed to obtain failing responses are also used to help bypass the simulation of passing patterns that do not pulse the required clock(s) for a candidate fault. Information regarding which patterns cause a given signature is not kept, leading to the relatively small size of the dictionary. In contrast to the effect-cause diagnosis process described in the previous section, the initial list of fault candidates is obtained by looking up the dictionary with the signature of observed failing response as the key. FIG. 1 shows the manner in which the initial list of fault candidates is obtained when the dictionary is used instead of using backtracing as shown in FIG. 2. However, since the saved dictionary does not contain information on the patterns that caused a stored signature, the initial candidates from the dictionary are simulated to verify that they explain the observed failing response for a pattern. One of the main reasons for the reduced run-time using the signature-based dictionary is that hyperactive faults that are included in the initial list of candidates by backtracing are not likely to be in the initial candidate fault list obtained from the dictionary, and thus will not be simulated. Hyperactive faults refer to faults that create many simulation events when simulated and thus take a long time to simulate. As noted earlier, the limitation of the signature-based dictionary approach is the size of the dictionary, which increases almost linearly with the number of test patterns.

### N_{FB} Dictionary

In order to reduce the size of the signature-based dictionary, a dictionary referred to as the N_{FB} dictionary was described in H. Tang et al., “Improving Performance of Effect-Cause Diagnosis with Minimal Memory Overhead,” Proc. Asian Test Symposium, pp. 281-287 (2007) and U.S. Patent Application Publication No. 2007/0226570, both of which are incorporated herein by reference. In the N_{FB} dictionary, signatures corresponding to failing patterns with only a few failing bits are stored. Typically, signatures for responses with 5 or fewer failing bits are saved in the dictionary based on the following observations. When the initial list of fault candidates is found by backtracing, the fault candidates are typically obtained by intersecting the logic in the input cones of the failing bits. Thus, the initial set of candidates tends to be large for patterns that have few failing bits. If signatures for responses with few failing bits are stored in a dictionary, the initial list of fault candidates for such patterns can be found by looking up the dictionary. For patterns with many failing bits, the initial set of fault candidates are found using backtracing as in the standard effect-cause diagnosis procedures.

An exemplary method of performing diagnosis using the N_{FB} dictionary is shown in FIG. 3. For a failing pattern, if the number of failing bits in the observed response is ≦N_{FB} (typically N_{FB}=5, though the number can vary from implementation to implementation), the initial list of candidates is obtained by looking up the candidates in the N_{FB} dictionary. If the number of failing bits for a pattern is >N_{FB}, however, the initial candidates are obtained using traditional backtracing. One potential problem with this approach is that when many patterns with failing bits more than N_{FB} occur, the diagnosis procedure essentially becomes the same as the traditional effect-cause procedure that does not use a dictionary. Because of this it was noted that for some large designs, N_{FB}-dictionary-based diagnosis procedures were considerably slower than the procedure using the small dictionary.

For example, consider the circuits given in Table 2 in which the circuits that will be referred to in the experimental results section of this paper are described. In Table 2, N_{Gate} is the number of gates in the design and N_{Obspt} is the number of observation points, including the primary outputs and the scan cells. N_{Pat} is the number of patterns in the pattern set used and N_{Saf} is the number of collapsed stuck-at faults in the design.

For design C5, the N_{FB}-dictionary-based effect-cause diagnosis procedure takes 8× times longer relative to the time taken by the small-dictionary-based procedure. Design C5, where the N_{FB} dictionary based diagnosis was slow, was analyzed in greater details, and it was found that a high percentage of faults causing large numbers of simulation events also caused larger than 5 observed outputs to fail. Accordingly, the signatures of the responses of these faults, called hyperactive faults in this work, were not stored in the N_{FB} dictionary (when N_{FB}=5). However, if one adds dictionary entries for faults which cause errors on more than 5 outputs to the N_{FB} dictionary, the dictionary could be too large for large designs. One possible solution to this issue is to store information for only a small subset of faults that cause errors on more than a limited number of outputs.

### Dictionaries for Hyperactive Faults

When used in effect-cause diagnosis procedures, dictionaries help to reduce the run time of diagnosis for the following reasons. One reason is the avoidance of backtracing to determine initial list of fault candidates. Another reason is that the dictionaries provide a list of initial candidates that are easy to filter as the fault simulation time for them is smaller.

When a partial dictionary such as the N_{FB} dictionary is used, backtracing is necessary when the signature of a failing pattern is not stored in the dictionary. As noted earlier, this causes higher run times. In order to improve the run time while preserving the small size of a dictionary, and in particular embodiments of the disclosed technology, two additional very small dictionaries can be used. These dictionaries can be used in addition to the N_{FB} dictionary or by themselves. Both these dictionaries store information about faults that cause high numbers of events during fault simulation. In the following discussion, these dictionaries are referred to as the “Failing Bit Count Dictionary” and the “Hyperactive Faults Signature Dictionary.”

### Failing Bit Count Dictionary

In one particular implementation of the Failing Bit Count (FBC) Dictionary, hypertrophic faults are used to help identify hyperactive faults. Hypertrophic faults are faults that cause many failing bits in a failing pattern. A hyperactive fault is a fault with a high number of simulation events. During event-driven simulation, one reason a high number of events can occur is because the fault effects propagate through many paths and are likely to reach many observation points. Hyperactive faults tend to be hypertrophic faults as well.

A simple and cost effective way of identifying a hypertrophic fault and avoid simulating it is to save the smallest number of failing bits such a fault causes over all patterns. Then, if a pattern that failed on a tester has fewer failing bits than the minimum number of failing bits saved for a fault f one can conclude that fault f will not match the observed response and hence can be dropped from the initial list of candidates without fault simulation. Next, the creation of the FBC dictionary is described.

Let T be the set of tests used to diagnose defects in the circuit under test. Let Tᵢ⊂ T be a subset of tests that detect a fault fᵢ. Then, the minimum failing bit count of fault fᵢ, written as minFB(fᵢ), is the smallest number of failing bits among responses to the tests in Tᵢ. For example, let f₁ be a fault detected by tests t₁, t₄ and t₇ in T. Let the number of failing bits when t₁, t₄ and t₇ are applied and fault f₁ is present be 13, 22 and 8, respectively. Then minFB(f₁)=8.

In deriving the FBC dictionary, all tests in T are simulated without fault dropping. During fault simulation to create the dictionary, the average number of events caused by a fault over all tests that detect it can be computed. Let Av_Event(fᵢ) be the average number of events caused by fault fᵢ.

In the Failing Bit Count (FBC) Dictionary, a pair (fᵢ, minFB(fᵢ)) can be entered for one or more faults (e.g., for each fault) which satisfies the following two conditions: minFB(fᵢ)≧MIN_{FB}, and Av_Event(fᵢ)≧MINEVENT, where MINFB=N_{FB}+2 and N_{FB} is the value used to generate N_{FB} dictionary. When N_{FB} dictionary is not used, N_{FB}=0 and MINFB=2. The reason for using MINFB=N_{FB}+2 is discussed below after the flow of diagnosis using FBC dictionary is described. In particular embodiments, MINEVENT is a user-specified minimum average event count, which qualifies a fault to be recorded in the FBC dictionary. An example of an FBC dictionary is shown in Table 1.

TABLE 1
Failing Bit Count (FBC) Dictionary

| Fault | minFB(fᵢ) |
|---|---|
| f₁ | 40 |
| f₂ | 33 |
| f₃ | 7 |
| f₄ | 12 |
| f₅ | 14 |

### Hyperactive Faults Signature Dictionary

To identify the hyperactive faults that are not hypertrophic, another structure to save information about them can be created. For example, in one exemplary embodiment, fault signatures can be used to distinguish between the hyperactive faults that may match the response observed on the tester and those that will not match the observed response. In this approach, the signatures of the hyperactive faults are saved and such faults are filtered out by looking up the failing pattern signature in a separate dictionary, referred to herein as the Hyperactive Faults signature (HFS) dictionary. If the signature of the observed response is not found in the dictionary, the corresponding fault can be dropped from the initial list of candidates without fault simulation.

In certain embodiments of the disclosed technology, the Hyperactive Faults Signature (HFS) Dictionary includes entries that are similar to those in the signature-based small dictionary and the N_{FB} dictionary. For instance, an entry in the HFS dictionary can be a 32-bit signature sᵢ of a faulty response and a set of associated faults Fᵢ. Each fault in the set Fᵢ produces a faulty response for some tests whose signature is sᵢ. In one particular embodiment, the signature sᵢ and the faults in the set Fᵢ satisfy the following conditions:
Signature sᵢ corresponds to failing response in which the number of failing bits is between a lower bound FB_Low and an upper bound FB_High. For instance, FB_Low can be set to N_{FB}+1, where N_{FB} is the value used to generate N_{FB} dictionary. When N_{FB} dictionary is not used, N_{FB} can be set to 0 and FB_low can be set to 1. In this embodiment, FB_High is used to limit the entries in the HFS dictionary and is usually set to 20 or a number that is the maximum number of failing bits in all the failing patterns to be diagnosed.
A fault f in Fᵢ produces a faulty response for some test whose signature is sᵢ and the Av_Event(f) is such that f is among the top X % of all faults arranged in decreasing order of their Average Event Count. In our experiments we used X=0.1. That is, a fault appears in the HFS dictionary only if the average number of events created by it in fault simulation places it at the top 0.1% of all faults in the circuit ordered by the average number of events created by them.

TABLE 2
Information on Some Industrial Circuits

| Circuit | C1 | C2 | C3 | C4 | C5 | C6 | C7 | C8 |
|---|---|---|---|---|---|---|---|---|
| N_{Gate} | 314K | 543K | 1.1M | 1.1M | 2.0M | 1.1M | 2.0M | 2.2M |
| N_{Obspt} | 20K | 46K | 64K | 70K | 134K | 58K | 129K | 144K |
| N_{Pat} | 5000 | 2252 | 1999 | 9415 | 1000 | 2656 | 3167 | 22982 |
| N_{Saf} | 631K | 1.1M | 1.7M | 1.8M | 4.2M | 2.1M | 4.1M | 3.9M |

### Dictionary Sizes

As discussed earlier, it is desirable to improve the performance of effect-cause diagnosis procedures using a dictionary whose size will permit accommodating large designs in the memories of engineering work stations. For the experimental results discussed herein, the base line used to evaluate the new dictionaries described in the previous section is the signature-based small dictionary described in W. Zou, W.-T. Cheng, S. M. Reddy, and H. Tang, “Speeding up effect cause defect diagnosis using a small dictionary,” Proc. of VTS, 2007.

TABLE 3
Hyperactive Faults Signature (HFS) Dictionary

| Signature | Fault |
|---|---|
| s₁ | f₃ |
| s₂ | f₃, f₄ |
| s₃ | f₄ |
| s₄ | f₆ |

The exemplary FBC and HFS dictionaries disclosed herein are typically used together. The combination of the two is referred to as a Hyperactive Fault (HF) Dictionary. Examples of FBC and HFS dictionaries are given in Table 1 and 3. The example FBC dictionary of Table 1 could be obtained when N_{FB}=5, MINFB=N_{FB}+2=7. The HFS dictionary of Table 3 could be obtained by setting FB_Low=N_{FB}+1=6 and FB_High=20 for the same circuit as the one used for Table 1. Note that faults f₁ and f₂ which appear in Table 1 do not appear in Table 3 since minFB(f₁) and minFB(f₂) are 40 and 33, which are higher than FB_High=20 used for the HFS dictionary of Table 3. Also, f₆ appears in Table 3 and does not appear in Table 1 since minFB(f₆)=6 which is less than MIN_{FB} used for the FBC dictionary of Table 1.

In Table 4, the sizes of the N_{FB} Dictionary with N_{FB}=5 and the Hyperactive Fault Dictionary for the eight circuits described in Table 1 are reported. The exemplary HF dictionary was created with MINFB=7, FB_Low=6, FB_High=20, MINEVENT=50, and X=0.1. From Table 4, it can be noted that the Hyperactive Fault (HF) dictionary size is negligible relative to both the N_{FB} dictionary and the signature-based small dictionary. Furthermore, if both the N_{FB} and the exemplary HF dictionaries described herein are used together for a circuit, the total size of the resulting dictionary will only be marginally higher than the size of the N_{FB} dictionary alone. On average the size of the HF dictionary is about 9% of the size of the N_{FB} dictionary.

### Exemplary Diagnosis Flow Using HF Dictionary

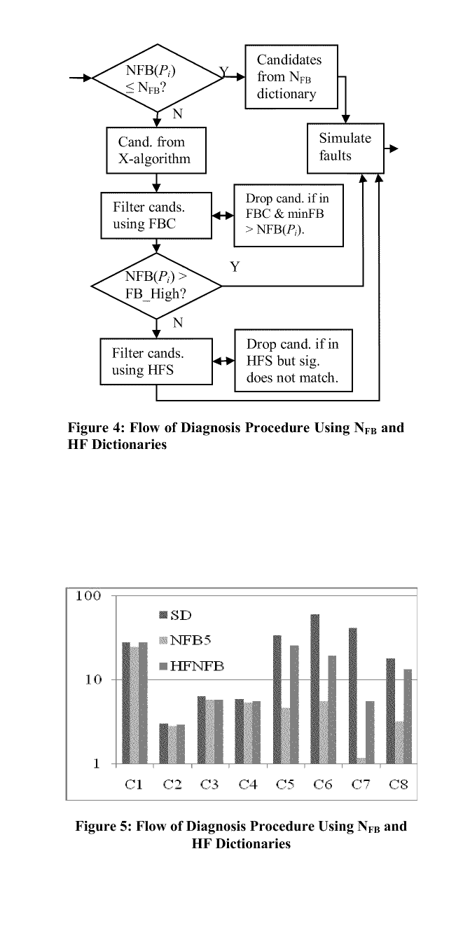

An exemplary diagnosis flow using both the N_{FB} and HF dictionaries together is shown in FIG. 4. The flow can be performed, for example, by modifying a commercial effect-cause-diagnosis-procedure-based tool to use dictionaries. Since only the analysis of failing patterns in the diagnosis procedures is changed when dictionaries are used, FIG. 4 just illustrates the analysis of the failing patterns.

For a failing pattern Pᵢ, if NFB(Pᵢ) (the number of failing bits in the observed response) is ≦N_{FB}, the N_{FB} dictionary is looked up to obtain the initial set of fault candidates, which are filtered using fault simulation to obtain the final list of candidates. If the number of failing bits for a pattern is >N_{FB}, the initial set of candidate faults is obtained using back tracing. This list is next filtered (pruned) by looking up the HF dictionary and subsequently filtered again using fault simulation. In filtering the fault candidate list using the HF dictionary, and in one exemplary embodiment, filtering is first performed using the FBC dictionary and then using the HFS dictionary.

Filtering of fault candidates using the FBC dictionary can be done in the following manner. For a failing pattern Pⱼ, for each fault fᵢ in the fault candidate list, fᵢ is looked up in the FBC dictionary. If fᵢ is found, the corresponding minimum number of failing bits minFB(fᵢ) is found. If minFB(fᵢ)>NFB(Pⱼ), fault f is dropped without fault simulation because all the patterns that detect fᵢ will have at least minFB(fᵢ) failing bits while the current failing pattern Pᵢ has NFB(Pⱼ)<minFB(fᵢ) failing bits. Otherwise, either the fault fᵢ is not found or minFB(fᵢ)≦NFB(Pᵢ) and fᵢ is retained in the candidate fault list, which is filtered next using the HFS dictionary.

The reason for using minFB=N_{FB}+2 in creating the FBC dictionary in this exemplary embodiment is explained below. From the flow of FIG. 4, when entering FBC dictionary filtering, NFB(Pᵢ) is at least N_{FB}+1, and by knowing minFB(fᵢ)=N_{FB}+1, one cannot conclude minFB(fᵢ)>NFB(Pⱼ) and drop fault fᵢ. Only when the stored minFB(fᵢ)≧N_{FB}+2 can such a conclusion be drawn. Accordingly, in particular embodiments of the disclosed technology, minFB is set to N_{FB}+2 when creating FBC dictionary.

After FBC dictionary filtering, if NFB(Pᵢ)>FB_High, filtering using HFS dictionary is skipped and the candidate fault list is filtered using fault simulation. The reason is that the HFS dictionary does not include signatures for patterns with failing bits over FB_High. According to one exemplary embodiment, if NFB(Pᵢ)≦FB_High, then the fault candidate list is filtered using the HFS dictionary in the following manner.

If the signature of the current pattern Pⱼ is sig(Pⱼ), it is looked up in the HFS dictionary and the set F(sig(Pᵢ)) containing faults that produced signature sig(Pⱼ) is acquired. If sig(Pⱼ) is not found, then F(sig(Pⱼ) is empty. For each fault fᵢ in the initial fault candidate list, the fault is looked up in the HFS dictionary to determine if it is in the dictionary. If fᵢ is in the dictionary but does not belong to the set F(sig(Pᵢ)) or if F(sig(Pᵢ)) is empty, the fault candidate fᵢ is dropped without fault simulation. After this filtering, the remaining fault candidates list are fault simulated.

### Using the Exemplary Diagnosis Flow

In this section, an example of using the diagnosis flow illustrated in FIG. 4 is described. Suppose a N_{FB} dictionary is created with N_{FB}=5 and assume that the FBC dictionary of Table 1 and the HFS dictionary of Table 3 are used. Note that minFB=N_{FB}+2=7 was used in creating the exemplary FBC dictionary, FB_Low=N_{FB}+1=6 and FB_High=20 was used in creating the HFS dictionary. Further suppose that there are two patterns, P₁ and P₂, that failed on the tester and let NFB(P₁)=3 and NFB(P₂)=8.

For pattern P₁, since NFB(P₁)=3<5, it can be determined that the fault candidates are saved in the N_{FB} dictionary, and the candidate list is obtained by looking up the N_{FB} dictionary.

For pattern P₂, since NFB(P₂)=8>5, the candidates can first be obtained from backtracing. Suppose the candidate list is {f₁, f₃, f₆, f₇}. By checking the FBC dictionary in Table 1, we know minFB(f₁)=40>8. Thus, fault f₁ is dropped without simulation. Since minFB(f₃)=7<8, fault f₃ is retained. We cannot find entries in the FBC dictionary for the other two faults, so we move on to the HFS dictionary. Suppose the failing pattern signature is s₂, then set F(sig(P₂))=F(s₂)={f₃,f₄}. Fault f₃ is in the HFS dictionary and also belongs to set F(s₂), so f₃ is kept. Fault f₆ is in the HFS dictionary but does not belong to set F(s₂), so fault f₆ is dropped. An entry for fault f cannot be found in the HFS dictionary, so it is retained. The final candidates before fault simulation are now {f₃, f₇}. This candidate fault list then goes through fault simulation to determine if any of them match the observed response.

### Experimental Results

Experiments were performed using the exemplary method shown in FIG. 4. In particular, the diagnosis flow described in the last section was performed for 100 randomly injected stuck-at defects in each one of the eight circuits shown in Table 1. As discussed earlier, one possible advantage of the method is to increase the throughput of volume diagnosis by speeding up effect cause diagnosis procedures. The speed-up can be obtained without sacrificing diagnosis quality measured by diagnostic resolution. All the methods considered returned the same final list of candidates as the base line standard effect-cause diagnosis procedure independent of what type of fault was injected or diagnosed. The diagnosis result is also the same as effect-cause diagnosis independent of the size of the HF dictionary.

Reported below are the average speed up for the 100 defects diagnosed using a commercial effect-cause diagnosis procedure using the signature-based small dictionary, the N_{FB} dictionary with N_{FB}=5, and the N_{FB} dictionary supplemented by the HF dictionary as described in this disclosure.

In FIG. 5, the speed-up factor relative to the base line effect-cause diagnosis procedure which does not use a dictionary is reported. The speed-up factor can be obtained by averaging the ratio of the run time of the base line procedure and the procedure augmented by using a dictionary and averaging the ratios for the 100 test cases. In FIG. 5, SD stands for the procedure using the signature-based dictionary, N_{FB} stands for the procedure using the N_{FB} dictionary, and HFNFB stands for the procedure using together the N_{FB} and the HF dictionaries. As expected, SD gives the best speed up, but as was discussed earlier, the size of the SD dictionaries could be too large to accommodate in a large workstation for very large industrial designs. The HFNFB-based procedure outperforms the NFB-based procedure for all circuits. The dictionary sizes for HFNFB procedures are only marginally higher than that for the N_{FB} procedures. For six of the eight circuits, the speed-up using the HFNFB-based procedure is close to that for the procedure using SD even though, as noted earlier, the dictionary sizes for the HFNFB procedure is a fraction of the dictionary for SD procedure. On average, for the eight circuits, the HFNFB procedure achieves over 13× speed up relative to the base line effect-cause procedure.

TABLE 4
Sizes (in MB) of Small Dictionary, N_{FB} and HF Dictionaries

| Size (MB) | C1 | C2 | C3 | C4 | C5 | C6 | C7 | C8 |
|---|---|---|---|---|---|---|---|---|
| SD | 85 | 108 | 104 | 279 | 333 | 252 | 597 | 2,771 |
| NFB5 | 14 | 22 | 19 | 42 | 72 | 43 | 88 | 211 |
| HF | 1 | 1 | 3 | 4 | 1 | 3 | 5 | 53 |

Table 5 gives the absolute time of diagnosing the failing patterns. E-C stands for the baseline effect-cause diagnosis without usage of any dictionary. The savings in absolute time for HFNFB over NFB5 is considerable.

TABLE 5
Average Failing Pattern Process Time for Each Case in Seconds

| Time | C1 | C2 | C3 | C4 | C5 | C6 | C7 | C8 |
|---|---|---|---|---|---|---|---|---|
| SD | 0.65 | 7.69 | 3.86 | 71.53 | 8.38 | 9.19 | 18.01 | 49.70 |
| NFB5 | 0.74 | 8.26 | 4.26 | 79.23 | 62.32 | 99.42 | 641.00 | 286.03 |
| HFNFB | 0.65 | 8.00 | 4.24 | 75.24 | 11.09 | 28.74 | 133.80 | 67.83 |
| E-C | 18.43 | 23.00 | 24.63 | 421.20 | 286.64 | 557.11 | 743.00 | 902.30 |

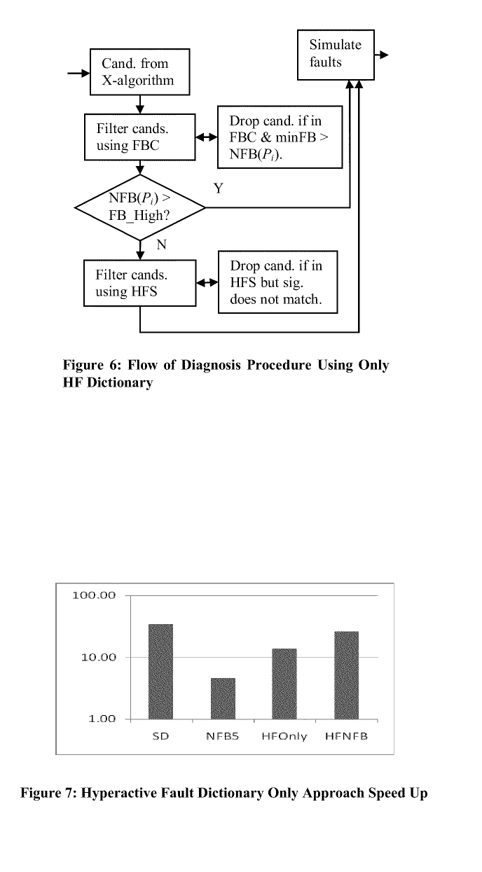

For circuits with a large proportion of hyperactive faults, using the HF dictionary alone could provide better performance than using the N_{FB} dictionary even though the HF dictionary size is a fraction of the size of the N_{FB} dictionary. The diagnosis flow for this case is shown in FIG. 6. All the initial candidate faults are obtained using backtracing. The FBC-and-HFS-dictionary-based filtering is applied to these candidates.

In FIG. 7, the speed up factors for circuit C5 for the procedures SD, NFB5, and HFNFB and HFOnly (which uses only the HF dictionary) are reported. It can be seen that the HFOnly procedure is 3× faster than the NFB5 procedure, even though the HF dictionary size is only 1.1% of the size of the N_{FB} dictionary. The reason for the speed up with a HF dictionary alone for C5 is due to the fact that this circuit has a high proportion of hyperactive faults that would have required large simulation times if they were not eliminated without simulation by looking up the HF dictionary.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

What is claimed is:

1. One or more computer readable media storing computer-executable instructions for causing a computer to perform any of the new and nonobvious methods or method acts described herein both alone and in combinations and subcombinations with one another.

2. A method of speeding up fault diagnosis comprising any of the new and nonobvious methods or method acts described herein both alone and in combinations and subcombinations with one another.

3. One or more computer readable media storing fault dictionaries generated at least in part by any of the new and nonobvious methods or method acts described herein both alone and in combinations and subcombinations with one another.

4. A diagnosis system that identifies one or more defects in integrated circuits using any of the new and nonobvious methods or method acts described herein both alone and in combinations and subcombinations with one another.

5. An integrated circuit diagnosed according to any of the new and nonobvious methods or method acts described herein both alone and in combinations and subcombinations with one another.

6. All new and nonobvious aspects of the disclosed technology performed as one or more method acts both alone and in combinations and subcombinations with one another or implemented as one or more computer-readable media storing computer-executable instructions for causing a computer to perform the method acts both alone and in combinations and subcombinations with one another.
